(19) United States
(12) Patent Application Publication
(10) Pub. No.: US 2004/0043504 A1
(43) Pub. Date: Mar. 4, 2004

(54) Automated sample preparation

(76) Inventors: Rene Buhler, Dietikon (CH); Rudolf Huber, Dietikon (CH); Werner Lautenschlager, Leutkirch (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/233,978

(22) Filed: Sep. 3, 2002

(51) Int. Cl. B01L 3/00

(52) U.S. Cl. 436/174; 422/99

(57) ABSTRACT

In a method for [For] acquisition of data for the preparation of laboratory samples, the weighing data are transferred from a balance to a computer unit. The weighing data are stored not only on a database, but rather a method-specific storage is done in which the actual weighing data are stored and are coordinated with the corresponding preparation method. Thus the computer unit can automatically derive further physical quantities that typically occur in a sample preparation from the actual weighing data, previous weighing data and with consideration of the actual and/or previous preparation method. Such quantities can be, for example, concentration, degree of moisture, etc.

The present invention concerns a method for automated data acquisition for the preparation of laboratory samples, a software product for implementation of such a method and a system for automated data acquisition for the preparation of laboratory samples.

The technical area of the present invention is generally the preparation of samples, that is, the preparation of materials that are to be tested in a laboratory, for example, for analytical purposes. Sample preparation generally involves several steps, such as dissolution in solvents, separation and/or screening, evaporation and concentration, ashing, drying and microwave-supported digestion. It was found that, when considering all the activities carried out in a laboratory, sample preparation is by far the most time-consuming part. Correspondingly, any further development in the direction of efficient laboratory data management should deal with this important time component. Generally, the task of the present invention is therefore to improve sample preparation in the laboratory.

A simple component of all sample preparations is the weighing of the samples before and/or after each preparation step. In the area of weighing technology, it is already known that electronic balances can be provided with an interface in order to transfer the weighing data into a separate database. Furthermore, it is known in the state of the art that the calibration data can be transferred to the balance from a separate database. However, these approaches are isolated solutions that are insufficient for integration of the sample preparation processes.

Based on this, it is the task of the present invention to further automate sample preparation, or more accurately, the integrated detection and processing of the data that are obtained during sample preparation in the laboratory.

One insight is that a balance plays the central role in sample preparation. Correspondingly, the present invention proposes to use the weighing data as a basis for automated data acquisition for the preparation of laboratory samples. However, the invention is not satisfied with simple storage of the weighing data in the databases, as it is known at the present time, but rather the weighing data are further processed, that is, stored in a specific way that permits further processing. Thus, the balance itself will become a central system in the laboratory.

Therefore, according to a first aspect of the present invention, a method is provided for automated data acquisition for the preparation of laboratory samples, where the acquisition is based on the weighing data from the balance. The balance is connected to a computer unit and/or itself has a computer unit. According to the invention, from the weighing data, automatically practically all the other quantities that typically occur during sample preparation can be derived (for example, moisture content, concentration, etc.). This is done by linking the weighing data to each other and to the present and/or previous preparation steps (called methods).

According to another aspect of the invention, a sequence that reflects the preparation methods leading to the preparation as a module is entered into the computer unit. The weighing data obtained in the course of performing the preparation methods are stored automatically and this storing is always coordinated with the corresponding preparation method and thus is done specifically to the method. This specifically assigned storage also makes it possible to farther process the weighing data in the sense of a derivation of other typical quantities in a sample preparation.

The modules can be displayed graphically as icons.

The determined weight of the sample container, in which the samples are present, can be used for identification of the samples.

The sequence can be shown in a modular manner in a tree structure.

Alternatively to, or in addition to, the real measured weighing data, estimated weighing data can be entered, which are always coordinated with the corresponding preparation method.

The estimated and real weighing data can be displayed differently (for example, by using different fonts).

The balance itself may have a display function that displays the actual status of the sample preparation sequence.

The weighing data can be evaluated automatically as quality control.

The densities of the samples and preparation materials can be entered in order to derive volumetric quantities from the weighing data.

According to yet another aspect of the present invention, a software product is provided that implements the method described above when it is loaded into the memory of a computer unit.

According to yet another aspect of the present invention, a system is provided for automated acquisition of data for the preparation of laboratory samples, where the system has at least one balance connected to a computer unit and/or has a computer unit itself. The weighing data are then transferred to the computer unit. With consideration of the present and/or previous preparation methods (preparation steps), the computer derives from the weighing data other typical quantities in sample preparation, for example, density, concentration, etc.

A sequence reflecting the preparation methods that must be performed in the preparation can be implemented as a module in the computer unit according to another aspect of the invention. The computer unit automatically stores tbe weighing data obtained in the course of carrying out the preparation methods, always coordinated with the corresponding preparation methods. Thus, for example, the computer unit can derive automatically from the weighing data at least one quantity that is typical of the preparation.

The modules of the sequence can be displayed graphically as icons on a display unit of the balance and/or of a separate computer unit.

Practical examples of the present invention will be explained below with reference to the figures of the attached drawings, so that further advantages, attributes and characteristics of the invention will become clear to the person skilled in the art.

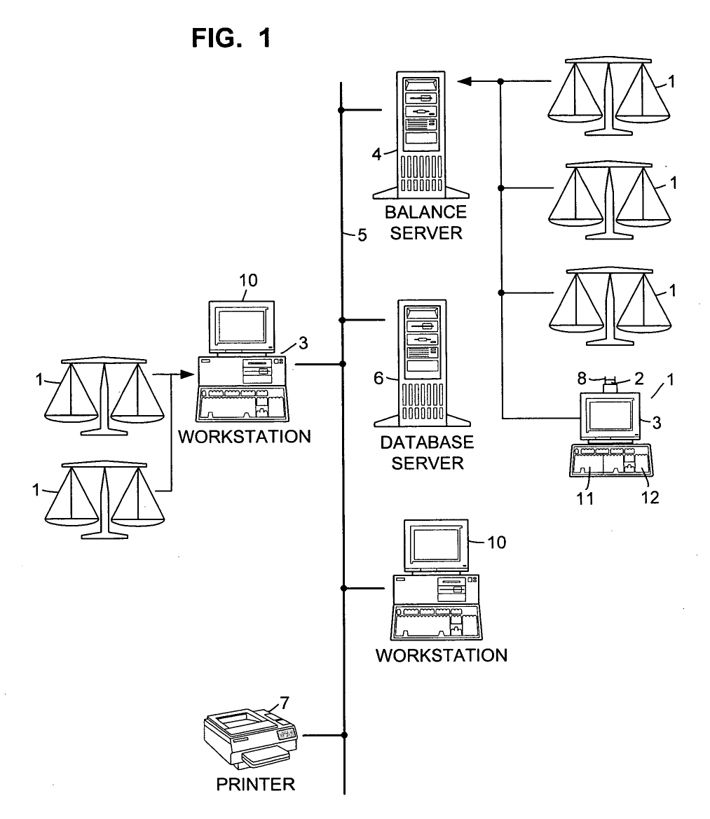

FIG. 1 shows a schematic view of a networked system for automated acquisition and/or further processing of sample preparation data,

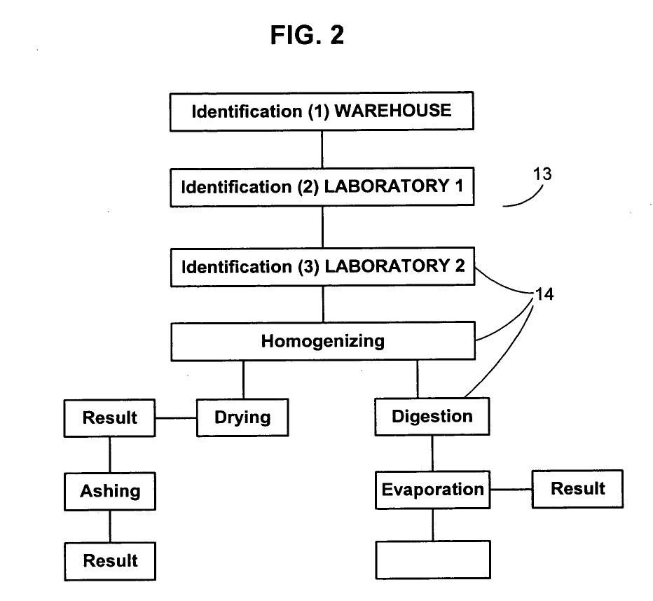

FIG. 2 shows a schematic view of a sample preparation sequence, where the sequence is structured as a tree, and

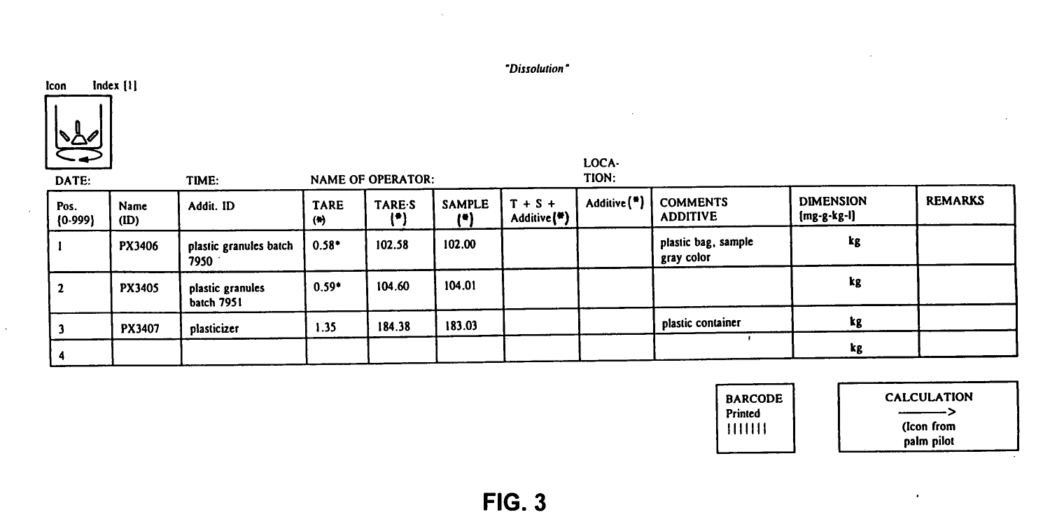

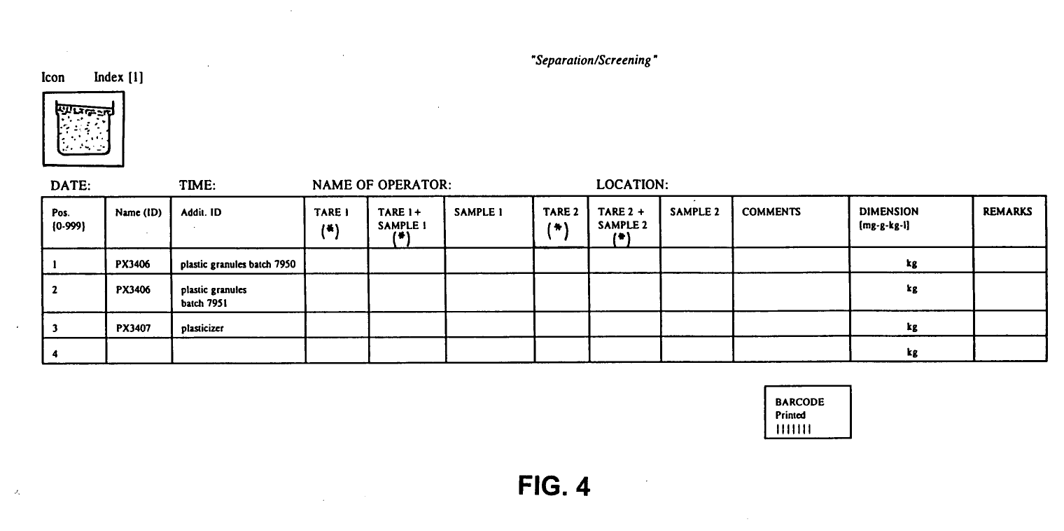

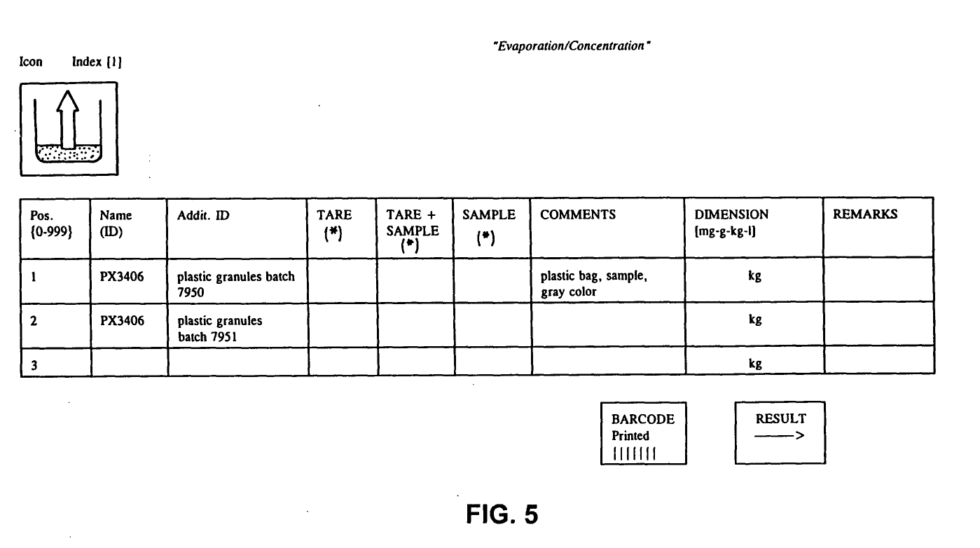

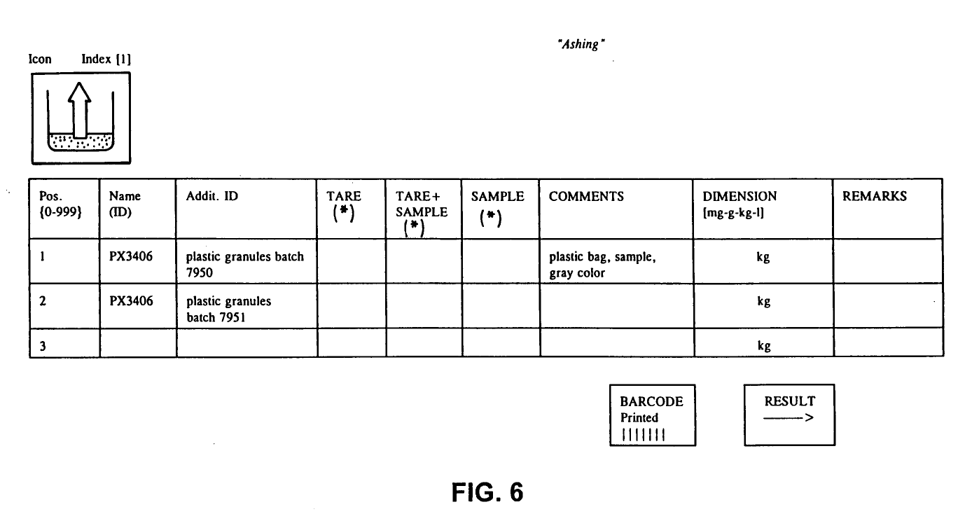

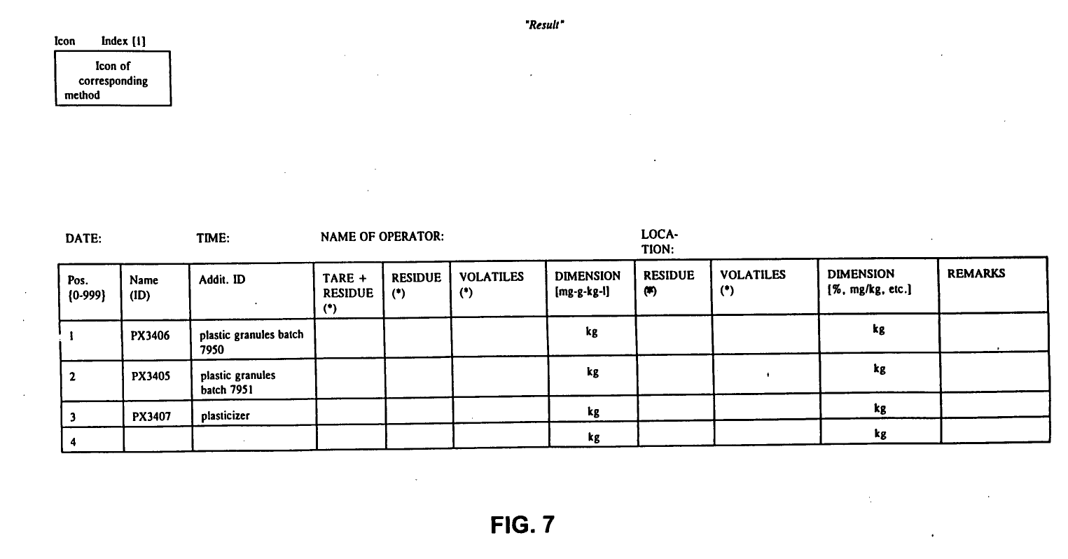

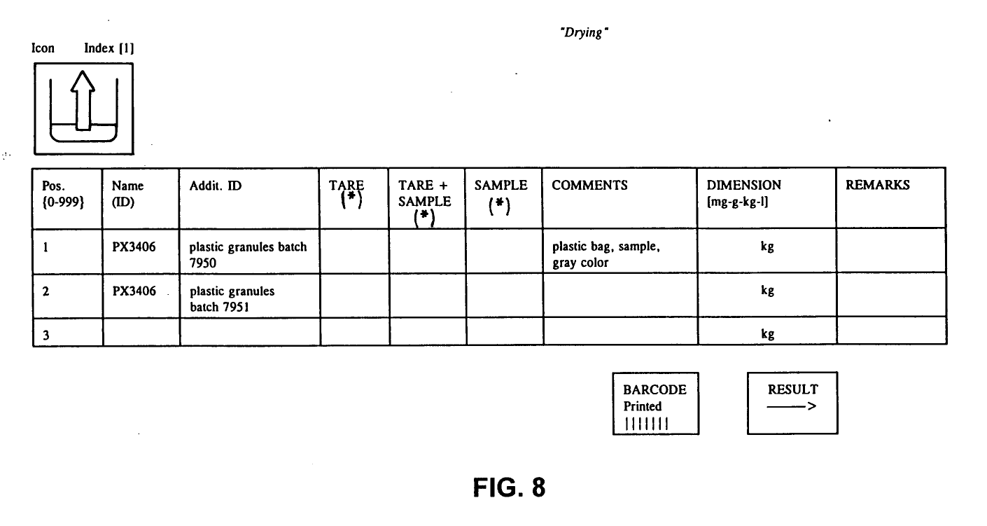

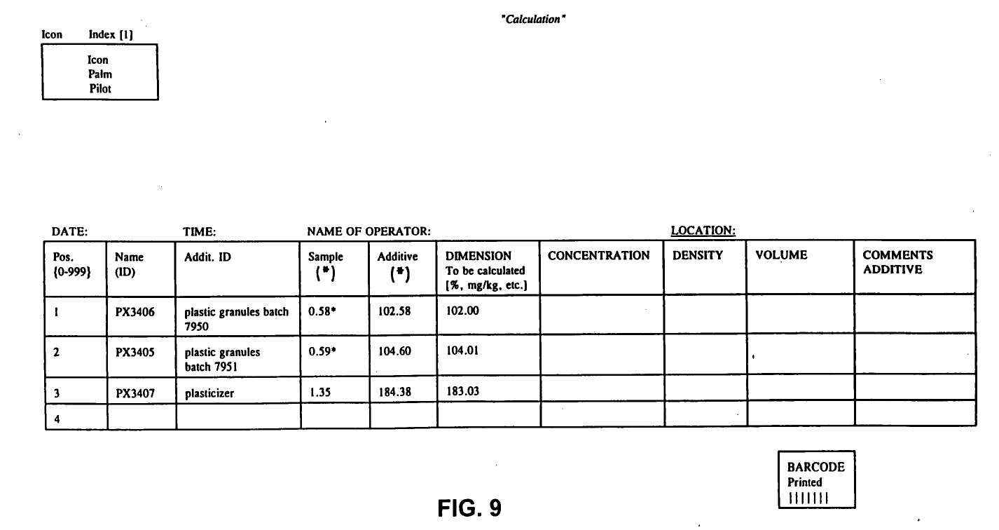

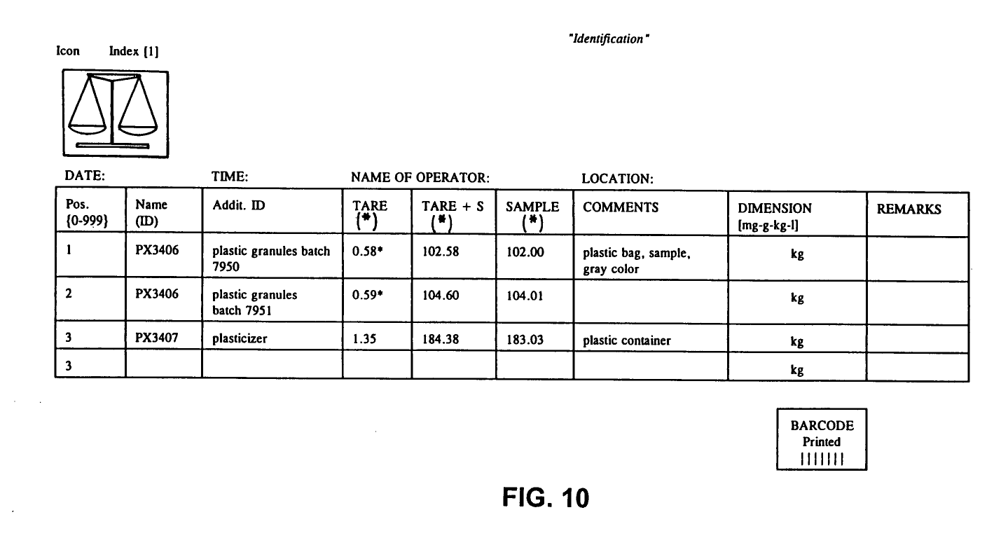

FIGS. 3 to 10 show different sample preparation methods as examples, their corresponding icons, which are to appear on a screen, as well as the method-specific storage of weighing data that occur in the course of carrying out the corresponding sample preparation method.

FIG. 1 shows a system, connected through a network 5, for automated acquisition and/or further processing of data that occur during the preparation of sample materials 2, present, for example, in the sample containers 8. One or several balances 1 are provided as central element in the sequence of sample preparation. Each of the balances 1 has an interface through which they are connected to a computer unit, for example, a workstation (PC) 3 or a server 4. The balances themselves may have a computer unit 9.

As customary, the PCs have a monitor 10 as display unit but, in addition, at least some of the balances 1 can be equipped with a screen 11, next to or (in case of the so-called touch screen) in keyboard 12. Other customary elements for a network such as a database server 6, a printer 7, etc., may be connected.

A sample preparation sequence can be divided into various steps, called sample preparation methods. Depending on need, the sample materials 2 are weighed on a balance 1 during and after each sample preparation method. According to the invention, the data obtained in this weighing process are not just entered, for example, in the database server 6, but rather a method-specific storage of the weighing data is performed and optionally also automatically other (physical) quantities are derived from the weighing data, as are typical for sample preparation and for characterization of the samples.

In order to derive at least one additional physical quantity from the weighing data; the balance server 4 or the workstation 3 links the actual weighing data to:

weighing data from the previous sample preparation methods, and

the actual and/or previous sample preparation methods themselves.

For example, in order to be able to derive volumetric quantities from the weight data, the specific densities of the samples and/or sample preparation materials are entered in the database server 6.

FIG. 2 shows a tree-structure sequence of a sample preparation. The tree 13 is divided into modules 14 that reflect the particular sample preparation methods. As shown in FIGS. 3 to 10, all sample preparation methods present as modules 14 in tree structure 13 can also be shown by a symbolic representation, namely by icons.

In a typical sample preparation, first the methods to be carried out during the sample preparation are established, by entering them according to the tree structure 13 of FIG. 2, for example, in workstation 3. The individual methods are connected modularly to the tree structure until the entire sample preparation sequence to be performed is set up. The modules can be arranged graphically at the edge of the screen or can be arranged according to their description and, in this case, the composition to the tree structure can be done with the aid of a “drag-and-drop” technique.

When this sample preparation is to be performed, the tree structure according to FIG. 2 appears on monitor 10 of the workstation 3 optionally just graphically represented by icons. Alternatively or in addition to his, this tree structure can also be displayed as icons on screen 11 of a balance 1. The sample preparation must be performed now according to the steps given in tree structure 13. A weighing process on a balance 1 is carried out before, during and/or after each sample preparation step given in tree structure 13.

The weighing data according to the actual weighing process can thus be stored, for example, in the database server 6, specifically to the method and especially assigned to the actual sample preparation method. In other words, the weighing data are stored not only in a database, but rather the storage is done in the context of the actual and optionally also previous sample preparation methods. This method-specific storage makes it possible to derive additional physical data from the weighing data in the computer unit, for example, PC

On screen 11 of a balance 1, the user recognizes the actual status of the sample preparation sequence, that is, at which sample preparation method of tree structure 13 the sequence is located. Thus, the user is instructed at balance 1 as to which steps are to be performed. Moreover, the weighing data are not blindly stored in database server 6, but rather the user can see on screen 11 if the storage of the actual weighing data was assigned correctly. The keyboard 12, which can also be designed as a touchscreen field, as mentioned above, can make it possible for the user to change the assignment of the storage of the weighing data, for example, to scroll through them and optionally scroll through the entire sample preparation sequence.

As stated above, at the balance, the user can determine the column in which the input of the sample preparation sequence is located and, moreover, positioning within the sample preparation sequence is possible at the balance itself.

Due to screen 11 and the control keys (keyboard) 12, thus unnecessary pathways between balance 1 as central elements of the sample preparation and PC 3 are omitted and the PC can be installed complete with files.

For example, in the sense of a quality control, the tare weight of sample container 8, in which a special sample 2 is present, can be used for identification of the sample, since, in the case of accurate measurements, none of the sample containers has the same weight as any other sample container.

By protocolling the entire sequence quality control and quality assurance can be improved since cheating in a weighing process becomes almost impossible, since such cheating would have consequences for the entire further processing in the sample preparation sequence and thus would lead to contradictions in the subsequent calculations. Furthermore, through this documentation and protocolling, it can be determined which user carried out which sample preparation step (sample preparation method). Such a protocolling and documentation is absolutely necessary for quality certification of a laboratory.

The weight of the sample preparation container 8 can be determined exactly by a tare measurement and, for example, can be used as bar code for identification. This also reduces the risk of deterioration of the quality of the analysis and sample preparation, for example, by mixing up the samples.

A further increase in quality is obtained according to the invention by the fact that the sequence of sample preparation is graphically predetermined for the user, so that all handling that is to be performed is predetermined.

In addition to really measured weighing data, that is, weighing data obtained in the course of a weighing process on a balance 1, it can also occur that certain estimated weighing data must be entered. These are reproduced on monitor 3 or on the screen 11 of balance 1 graphically, completely separate from the really measured weighing data. For example, estimated (assumed) weighing data can be reproduced with a cursive font. As soon as during the sequence of sample preparation, at one point the estimated values can be replaced by actually determined weighing data, this replacement of estimated values by real measured values propagates backwards, that is, weighing data and/or quantities derived from it from previous sample preparation methods are automatically corrected correspondingly.

For example, by pressing a print key on balance 1, real determined weighing data can be transferred from the balance to the software and thus to the computer unit. On the other hand, if the data are estimated values that are entered with a keyboard, for example, of balance 1, these are automatically reevaluated by the software, separately from the real weighing data and are represented differently in the graphic form.

In addition to standardized sample preparation methods, naturally, individual ones can also be allowed. Yet, in the sense of a standardization, an attempt should be made to build up the sample preparation sequence through frequently-occurring laboratory methods. These are typically the following:

dissolution,

filtration,

separation/screening,

drying/ashing/ignition residue,

evaporation/concentration by evaporation/concentration,

homogenization/blending/mixing/grinding,

liquid-liquid or solid-liquid extraction,

centrifuging,

digestion/hydrolysis,

pH adjustment, etc.

1. Method for automated acquisition of data for the preparation of laboratory samples (2), where the acquisition is done based on weighing data from a balance (1), that is connected to a computer unit (3, 4) and/or itself has a computer unit (9),
characterized by the fact
that, with consideration of the actual and/or previous preparation methods, at least one other quantity that is typical of a sample preparation is derived from the weighing data.

2. Method for automated acquisition of data for the preparation of laboratory sample (2), where the acquisition is done based on weighing data from a balance (1), that is connected to a computer unit (3, 4) and/or itself has a computer unit (9),
where the method is characterized by the followings steps:
input of a sequence (13) that reproduces the preparation methods to be carried out for the preparation as a module (14), in the computer unit (3, 4, 9),
automatic storage of the weighing data obtained in the course of carrying out the preparation methods, where the storage is always done coordinated with the corresponding preparation method.

3. Method according to claim 2,
characterized by the fact
that further quantities typical for a preparation are derived automatically from the weighing data.

4. Method according to one of claims 2 or 3,
characterized by the fact
that the module (14) is reproduced on a display graphically as icons.

5. Method according to one of the previous claims,
characterized by the fact
that the detected weight of the sample container (8), in which the samples (2) are present, is used for identification of the samples (2).

6. Method according to one of the previous claims,
characterized by the fact
that the sequence of sample preparation is present in a tree structure (13).

7. Method according to one of the previous claims,
characterized by the fact
that alternatively or in addition to the real measured weighing data, estimated weighing data can be entered, which are always stored coordinated with the corresponding preparation method.

8. Method according to claim 7,
characterized by the fact
that estimated and real weighing data can always be displayed in a different graphic form.

9. Method according to one of the previous claims,
characterized by the fact
that the state in which the sequence is at a given time is displayed on the balance (1) itself.

10. Method according to one of the previous claims,
characterized by the fact
that the weighing data are evaluated for quality control.

11. Method according to one of the previous claims,
characterized by the fact
that the densities of the samples and preparation materials are entered in order to derive volumetric quantities from the weighing data.

12. Software product,
characterized by the fact
that when it is loaded into the memory of a computer unit (3, 4), it implements a method according to one of the previous claims.

13. System for automated acquisition of data for the preparation of laboratory samples (2), having at least one balance (1) that is connected to a computer unit (3, 4) and/or itself has a computer unit (9), where the weighing data are transferred to the computer unit (3, 4, 9) and the computer unit (3, 4, 9) derives from the weighing data at least one other typical quantity of the sample preparation with consideration of the actual and/or previous preparation methods.

14. System for automated acquisition of data for the preparation of laboratory samples (2), having at least one balance (1) that is connected to a computer unit (3, 4) and/or has a computer unit (9) itself, where
sequence (13) is implemented in the computer unit (3, 4, 9), reflecting the preparation methods to be carried out as module (14) and
the computer unit (3, 4, 9) stores automatically the weighing data obtained in the course of carrying out the preparation methods, always coordinated with the corresponding preparation method.

15. System according to claim 14,
characterized by the fact
that the computer unit (3, 4, 9) derives from the weighing data, automatically, other quantities that are typical of a preparation.

16. System according to claims 14 or 15,
characterized by
a display unit (10, 11) on the balance (1) and/or on a separate computer unit (3, 4).

17. System according to one of claims 13 to 16,
characterized by the fact
that the computer unit (3, 4, 9) uses the detected weight of the sample containers (8), in which the samples (2) are present for identification of the samples (2).

18. System according to one of claims 13 to 17,
characterized by the fact
that the sequence of sample preparation is present in a tree structure (13).

19. System [according to] one of claims 13 to 18,
characterized by the fact
that the computer unit (3, 4, 9) uses alternatively or in addition to real weighing data, measured weighing data that are always stored coordinated with the corresponding preparation method.

20. System according to claim 19,
characterized by the fact
that a display unit (10, 11) is provided on the balance (1) and/or on the separate computer unit (3, 4), which always shows the estimated and real weighing data in a different graphic form.

21. System according to one of claims 13 to 20,
characterized by the fact
that the balance (1) has a display unit (11) for showing the actual status of the sequence.

22. System according to one of claims 13 to 21,
characterized by the fact
that the computer unit (3, 4, 9) evaluates the weighing data for quality control.

23. System according to one of claims 13 to 22,
characterized by the fact
that in the computer unit (3, 4, 9) and/or in the balance (1), the densities of the samples and preparation materials used are stored in order to derive volumetric quantities from the weighing data.
